(19) United States
(12) Patent Application Publication
(10) Pub. No.: US 2015/0059769 A1
(43) Pub. Date: Mar. 5, 2015

(54) TOOTH IMPACT GUARD

(71) Applicant: Michael Powers, Nipomo, CA (US)

(72) Inventor: Michael Powers, Nipomo, CA (US)

(21) Appl. No.: 14/012,919

(22) Filed: Aug. 28, 2013

(51) Int. Cl. A41D 13/015; A61C 9/00

(52) U.S. Cl. CPC A41D 13/015; A61C 9/0006
USPC 128/861; 433/214

(57) ABSTRACT

A tooth impact protection guard incorporates a posterior portion with a labial margin substantially at a contour of an alveolar ridge. The posterior portion extends over an occlusal surface of each posterior tooth and covers the lingual cusps to a posterior lingual margin at the cemento-enamel junction. An anterior portion has a contiguous labial margin with the posterior portion at a contour of the attached alveolar ridge. The anterior portion terminates in an anterior lingual margin substantially adjacent an incisal edge of each anterior tooth with an overlap of between 2 and 5 mm.

### BACKGROUND INFORMATION

1. Field

Embodiments of the disclosure relate generally to the field of mouth and tooth protection devices and more particularly to a tooth impact guard incorporating a rigid inner layer received against the teeth and a soft outer layer, the guard profile having a lingual margin in an anterior portion terminating adjacent the lingual incisal edge.

2. Background

Athletes in sports such as football and basketball as well as other sports with physical contact may sustain contact blows to the mouth and teeth. Protection for the teeth to avoid damage or injury is therefore required. In many sports, the athletes are not allowed to play unless some form of mouth protection is worn. Typical “mouth guards” are fabricated from highly pliable foams or resins shaped to the upper teeth providing padding and shock absorbing properties. Typically, the mouth guard has a bridge extending over the roof of the mouth and is held in place by a combination of suction formed between the palate and bridge and the lower teeth gripping the bottom of the guard and urging it against the upper molars.

These typical mouth guards are large and restrict the tongue, impacting the ability to speak clearly. While some mouth guards eliminate some of the palatal bridge, the thick material required for adequate protection still hampers speech. In many sports generally or in specific positions such as football quarterback, verbal communication is imperative and the impediment created by the mouth guard is highly undesirable. Additionally, current mount guards are readily removable which may result in loss or displacement at a critical moment.

Technologies have been developed in the art of orthodontia for creating molded retainers to hold teeth in place once aligning braces are removed or in providing a series of retainers with modified sizing used incrementally to replace braces. These retainers employ rigid acrylic for increased retention and impact strength.

It is therefore desirable to provide a tooth impact guard which overcomes the shortcomings of the prior art to provide high impact protection for the teeth while minimally impeding the tongue allowing good verbal communication and having superior adherence to the teeth for retention in the mouth.

### SUMMARY

Embodiments disclosed herein provide a tooth impact protection guard having a posterior portion with a labial margin substantially at the alveolar ridge. The posterior portion extends over an occlusal surface of each posterior tooth and covers the lingual cusps to a posterior lingual margin. An anterior portion has a contiguous labial margin with the posterior portion at the alveolar ridge. The anterior portion terminates in an anterior lingual margin overlapping an incisal lingual edge of each anterior tooth but terminating to expose the lingual surface.

In example embodiments, the guard is formed from an inner rigid acrylic layer and an outer soft acrylic layer.

A method for fabricating a guard as disclosed in the embodiments is accomplished by taking an impression of an athlete's teeth to create a female mold and casting a male mold into the impression. A laminate of a hard acrylic inner layer and a soft acrylic outer layer is then thermoformed over the male mold covering all of the mold except the base to form a process intermediate. An anterior lingual margin is cut from the process intermediate to eliminate all lingual material from the guard in the anterior portion to form the completed guard.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

FIG. 1 is a side view of the upper teeth and jaw;

FIG. 2 is a bottom view of the upper teeth with an embodiment of the tooth impact guard in place;

FIG. 3 is a section view of an example posterior tooth demonstrating the lingual and labial margin;

FIG. 4 is a section view of an example anterior tooth demonstrating the lingual and labial margin;

FIG. 5 is a bottom perspective view of the tooth impact guard demonstrating the profile of the lingual and labial margins in the guard; and,

FIG. 6 is a flow chart of a method for tooth impact protection employing a device according to the disclosed embodiments.

### DETAILED DESCRIPTION

Embodiments disclosed herein provide a tooth impact guard having an inner layer formed of a rigid or hard acrylic (referred to herein as a rigid acrylic) and an outer layer formed of a flexible, compressible, energy absorbing acrylic (referred to herein as a soft acrylic). The added strength and retention provided by the inner rigid acrylic layer allows removal of all material from the roof of the mouth and from behind the front teeth. The removal of this material means there is no deleterious effect on speech, breathing or swallowing, and these are the major complaints associated with prior art mouthguards. The resulting guard has an outer upper profile or labial margin which extends proximate to the alveolar ridge adjacent all teeth and an inner upper profile or lingual margin that extends to the cemento enamel junction adjacent the posterior teeth but is relieved substantially to but overlapping the lingual incisal edge adjacent the anterior teeth. The desired high impact protection for the teeth while minimally impeding the tongue with superior adherence to the teeth for retention in the mouth is accomplished by the combination of the soft resin exterior with the rigid resin interior and the relieved lingual margin.

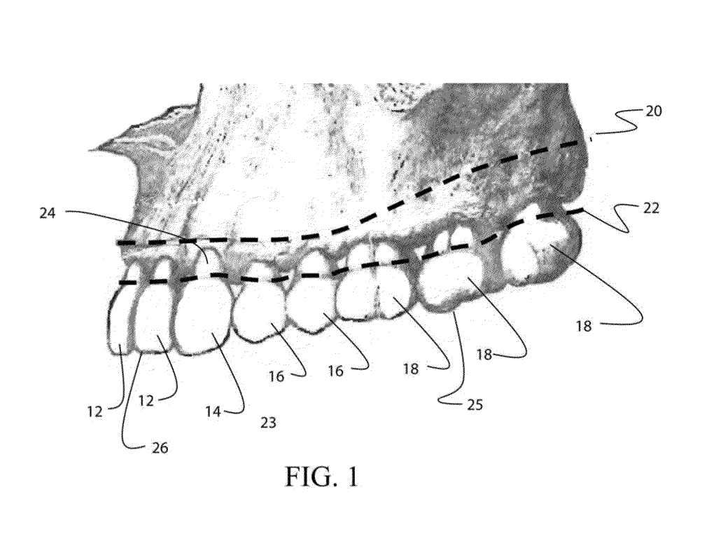

Referring to the drawings, FIG. 1 shows in side view an exemplary upper jaw 10 with teeth including incisors 12, canines 14, premolars 16 and molars 18. The incisors and canines are defined as anterior teeth and the premolars and molars are defined as posterior teeth herein. The alveolar ridge, shown generally by profile 20, is a median defining the extent of the alveolar bone which surrounds the roots of the teeth. The cementoenamel junction (CEJ), shown generally by profile 22 defines the separation between the crown 23 and root 24 of the teeth. Typically, the attached gingiva, gum tissue which surrounds the roots of the teeth, is directly attached to the alveolar bone. The posterior teeth terminate in an occlusal 25 which forms the biting surface of the tooth. The anterior teeth terminate in an incisal edge 26.

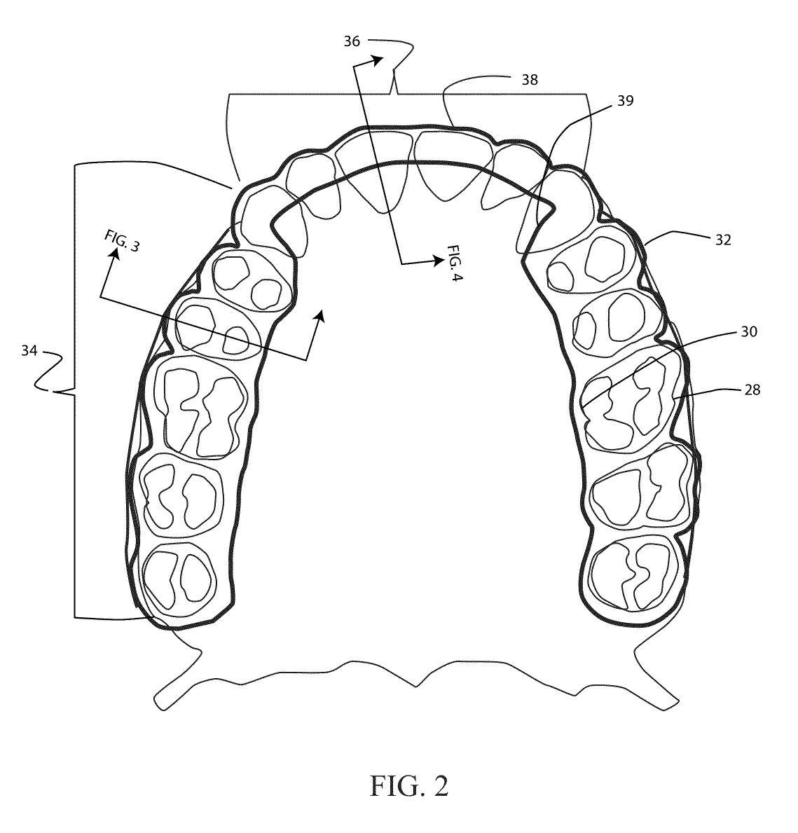

As shown in FIG. 2, all of the teeth have a labial surface 28 adjacent the cheek or lips and a lingual surface 30 facing the tongue or interior of the mouth. The tooth impact guard 32 is formed with a posterior portion 34 to surround the posterior teeth covering the labial surface, occlusal and lingual surface, as will be described in greater detail subsequently. An anterior portion 36 of the guard covers the labial surface of the anterior teeth terminating at an anterior lingual margin 38 which overlaps the incisal edge 26 but terminates to expose the lingual surface of the anterior teeth. For the embodiment shown, the lingual margin 38 terminates on each side of the guard at the cuspid midline ridge 39 on the canine teeth 14.

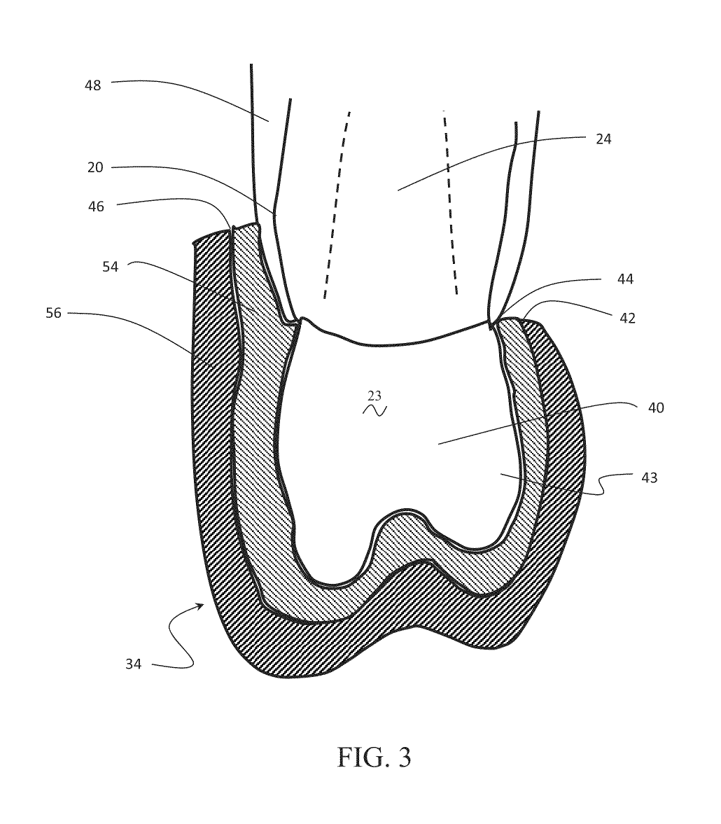

As seen in FIG. 3 for an example posterior tooth, the posterior portion 34 of the guard 32 covers each posterior tooth 40 from a posterior lingual margin 42 covering the lingual cusps 43 and extending substantially to the height of the contour of the posterior teeth terminating substantially at the lingual CEJ 44. A labial margin 46 extends substantially to the alveolar ridge 20 following the contour of attached gingiva 48.

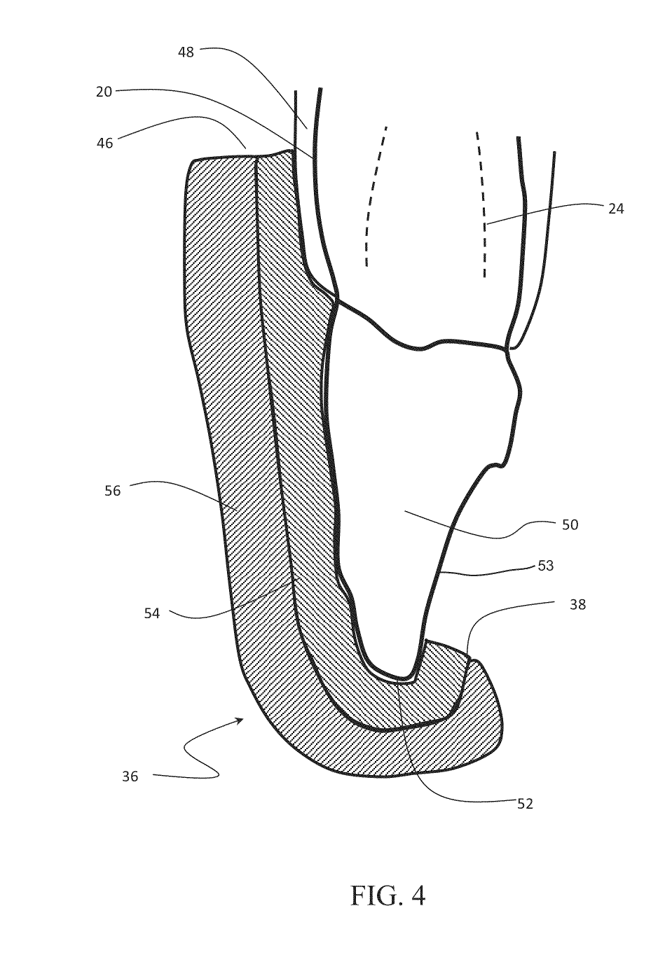

The anterior portion 36 of the guard 32 covers the labial surface of each anterior tooth 50 but terminates as previously described, at an anterior lingual margin 38 overlapping incisal edge 52 but terminating to expose the lingual surface 53 of the anterior teeth as shown in FIG. 4. For safety and protection, complete encapsulation of the incisal edge is desirable. This requires extension of the lingual margin down the lingual surface from the incisal edge and because of the height variations of incisal edges this would vary from 2 to 5 mm. As with the posterior portion 34 of the guard, the labial margin 46 on the anterior portion 36 is contiguous with the posterior portion 38 and extends to the alveolar ridge 20 following the contour of attached gingiva 48. The removal of all lingual material from the guard 32 except for the essential covering of the lingual cusps in the posterior teeth allows for unencumbered speech, swallowing and breathing functions, all of which are compromised by conventional prior art mouth guards with full lingual coverage and, often, coverage of the palate.

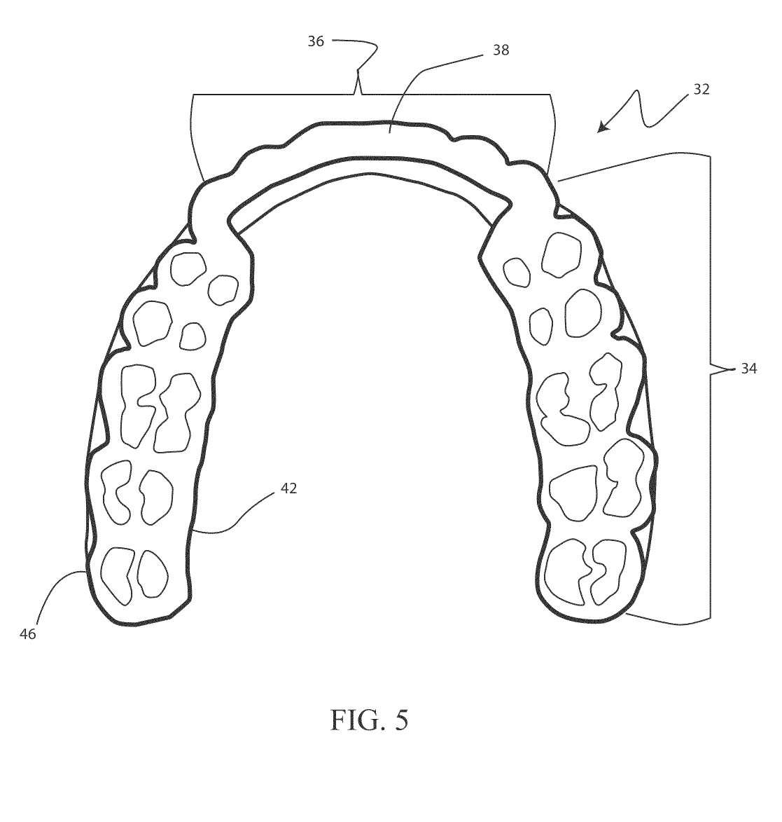

FIG. 5 shows the guard 32 with the anterior lingual margin 38, the labial margin 46 for both the anterior and posterior portions of the guard and the posterior lingual margin 42 shown with the guard removed from the teeth.

Returning to FIGS. 3 and 4, as seen in both figures the guard 32 is a layered construction having an inner rigid acrylic layer 54 and an outer soft acrylic layer 56. The rigid inner layer provides impact strength significantly greater than prior art mouth guards which employ only soft acrylic. This results in greater resistance to lateral or occlusal forces that may fracture or evulse a tooth. The inner rigid acrylic layer 54 is molded to be closely received by the teeth, as will be described in greater detail subsequently. This close contact by the inner rigid acrylic layer increases retention sufficiently to allow removal of essentially all lingual material while still leaving the guard with greater retention than prior art mouth guards. No external forces contact the lingual portions of the maxillary teeth.

For exemplary embodiments, the guard 32 employs a Cyclo-Olefin Copolymer (COC) or a polyethylene terephthalate-glycol modified (PETG) as the inner rigid acrylic layer 54. COC provides a 60 MPa ultimate tensile strength while PETG provides an ultimate tensile strength of 53 MPa. Desired tensile strength in a range of 50-65 MPa may be employed for alternative rigid acrylics in alternative embodiments. A thickness of 1 to 2 mm is preferred for the inner layer. The outer soft acrylic layer 56 of the guard employs ethylene vinyl acetate (EVA) for a soft, compressible and energy absorbing layer. Formulations of 10% to 30% by weight provide 3 MPa to 35 MPa ultimate tensile strength in the EVA. In alternative embodiments, alternative soft acrylics having comparable tensile strength, elasticity and resilience to EVA such as thermoplastic polyurethanes (TPU) may be employed. The outer soft acrylic layer 56 is between 2 and 4 mm in thickness with a preferable 3-4 mm thickness for example embodiments.

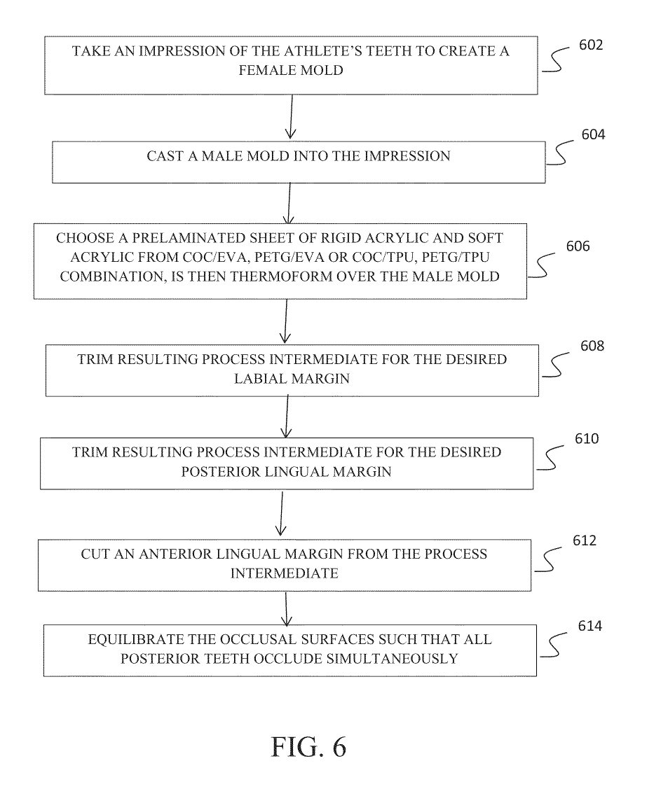

As shown in FIG. 6 fabrication of the guard 32 is accomplished by taking an impression of the athlete's teeth to create a female mold, step 602. A male mold is then cast into the impression, step 604. A prelaminated sheet of rigid acrylic and soft acrylic from a chosen COC/EVA, PETG/EVA or COC/TPU, PETG/TPU combination, is then thermoformed over the male mold with the rigid acrylic interfacing the teeth in the mold, step 606, covering all of the mold except for the base. The resulting process intermediate is then trimmed for the desired labial margin 46, step 608, and posterior lingual margin 42, step 610. In certain molding processes, the labial margin and/or the posterior lingual margin maybe completed as a portion of the molding. An anterior lingual margin 38 is cut from the process intermediate, step 612, to eliminate all lingual material from the guard in the anterior portion to form the completed guard. As previously described for exemplary embodiments, the anterior lingual margin may extend between the cuspid midline ridges 39. The occlusal surfaces are then equilibrated so that all the posterior teeth occlude simultaneously, step 614.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims.

What is claimed is:

1. A tooth impact protection device comprising:
a guard having
a posterior portion with a labial margin substantially at a contour of an alveolar ridge, the posterior portion extending over an occlusal surface of each posterior tooth and covering lingual cusps to a posterior lingual margin; and,
an anterior portion having a contiguous labial margin with the posterior portion at a contour of the alveolar ridge, the anterior portion terminating in an anterior lingual margin overlapping an incisal edge but terminating to expose a lingual surface of each anterior tooth.

2. The tooth impact protection device as defined in claim 1 wherein the posterior lingual margin extends substantially to a lingual cemento enamel junction (CEJ).

3. The tooth impact guard as defined in claim 1 wherein the anterior lingual margin terminates at a cuspid midline ridge.

4. The tooth impact protection device as defined in claim 1 wherein the guard is formed from a rigid acrylic inner layer and a soft acrylic outer layer.

5. The tooth impact protection device as defined in claim 4 wherein the rigid acrylic layer has an ultimate tensile strength of between 50 and 65 MPa.

6. The tooth impact protection device as defined in claim 4 wherein the soft acrylic layer has an ultimate tensile strength of between 3 and 35 MPa.

7. The tooth impact protection device as defined in claim 4 wherein the rigid acrylic inner layer is chosen from the set of COC and PETG.

8. The tooth impact protection device as defined in claim 4 wherein the soft acrylic outer layer is chosen from the set of EVA and TPU.

9. A method for fabricating a tooth impact protection guard comprising:
taking an impression of an athlete's teeth to create a female mold;
casting a male mold into the impression;
thermoforming a laminate of a hard acrylic inner layer and a soft acrylic outer layer over the male mold covering all of the mold except for a base to form a process intermediate;
cutting an anterior lingual margin from the process intermediate to eliminate all lingual material from the guard in the anterior portion to form the completed guard.

10. The method of claim 9 further comprising the step of selecting a prelaminated sheet of rigid acrylic and soft acrylic from a chosen cyclo olefin copolymer/ethylene vinyl acetate (COC/EVA), polyethylene terephthalate-glycol modified/ethylene vinyl acetate (PETG/EVA), cyclo olefin copolymer/thermoplastic urethane (COC/TPU) or polyethylene terephthalate-glycol modified/thermoplastic urethane (PETG/TPU) combination.

11. The method of claim 9 further comprising trimming the process intermediate for a desired labial margin.

12. The method of claim 9 further comprising trimming the process intermediate for a desired and posterior lingual margin.

13. The method of claim 9 wherein the anterior lingual margin is trimmed to extend between cuspid midline ridges.

14. The method of claim 10 wherein the step of selecting a prelaminated sheet of rigid acrylic and soft acrylic comprises choosing an interior rigid acrylic from 1 to 2 mm of cyclo olefin copolymer or glycol modified polyethylene terephthalate combined with an exterior soft acrylic from 3 to 4 mm of ethylene vinyl acetate or thermoplastic urethane.
